(19) United States
(12) Patent Application Publication
(10) Pub. No.: US 2024/0354454 A1
(43) Pub. Date: Oct. 24, 2024

(54) STOCHASTIC STRUCTURES

(71) Applicant: SIEMENS ENERGY GLOBAL GMBH & CO. KG, Munich (DE)

(72) Inventors: Adam Clare, Nottingham (GB); Jan-Hendrik Groth, Nottingham (GB); Mirco Magnini, Nottingham (GB); Christopher Tuck, Nottingham (GB)

(21) Appl. No.: 18/682,209

(22) PCT Filed: Sep. 7, 2022
(86) PCT No.: PCT/EP2022/074912

§ 371 Date: Feb. 8, 2024

(30) Foreign Application Priority Data
Sep. 16, 2021 (GB) 2113257.6
Sep. 16, 2021 (GB) 2113258.4

(51) Int. Cl. G06F 30/10; G06F 30/20; G06F 111/08; G06F 113/10

(52) U.S. Cl. CPC G06F 30/10; G06F 30/20; G06F 2111/08; G06F 2113/10

(57) ABSTRACT

A method of forming a stochastic structure, the method comprising the steps: selecting a parent structure, the parent structure defining an array of unit cells, initially the array of unit cells is uniform, defining each unit cell of the array of unit cells a size, a geometry, a relative density and at least one node, placing an implicit function of an object or part of an object at each node, wherein the object having parameters to define its position xcₙ, ycₙ, zcₙ, and extent rxₙ, ryₙ, and rzₙ or a shape defined by an equation having at least the parameters x, y and z, randomising any one or more of the parameters by applying a statistical distribution, the statistical distribution having a standard deviation σ, the standard deviation σ controls at least one of the three dimensions where random values of each parameter are created and selecting a value greater than zero of the standard deviation σ to define the degree of randomisation for any one or more of the parameters, thereby creating a randomised array of unit cells representative of the stochastic structure wherein the randomised array of unit cells forms three-dimensional volume data comprising iso-surfaces, the method comprising rendering the iso-surfaces with polygons having faces and vertices to form a solid model of the stochastic structure and optionally printing the stochastic structure in an additive manufacturing process.

### FIELD OF INVENTION

The present disclosure relates to a method of producing randomised or stochastic structures and in particular, but not exclusively articles having a stochastic structure such as biomimetic medical implants, heat exchangers and mechanical components.

### BACKGROUND

Fluid flowing through regular structures can form patterns of turbulence and stagnation reducing mass flow and/or efficiency of a system. One such structure is a heat exchanger. Another structure is a surface over which a fluid flows.

Regular structures can be susceptible to adverse structural behaviours such as resonant frequencies.

### SUMMARY OF INVENTION

Thus, an object of the present invention to improve fluid flow through structures or over surface. Another object is to improve structural behaviour of components, structures or systems.

The above objects are achieved by a method of forming a stochastic structure, the method comprising the steps selecting a parent structure, the parent structure defining an array of unit cells, initially the array of unit cells is uniform, defining each unit cell of the array of unit cells a size, a geometry, a relative density and at least one node, placing an implicit function of an object or part of an object at each node. The object having parameters to define its position xcₙ, ycₙ, zcₙ, and extent rxₙ, ryₙ, and rzₙ or a shape defined by an equation having at least the parameters x, y and z. Randomising any one or more of the parameters by applying a statistical distribution, the statistical distribution having a standard deviation σ, the standard deviation σ controls at least one of the three dimensions where random values of each parameter are created. Selecting a value greater than zero of the standard deviation σ to define the degree of randomisation for any one or more of the parameters. Thereby creating a randomised array of unit cells representative of the stochastic structure.

As mentioned, the parent structure defining an array of unit cells that is initially uniform. This means that the array of unit cells comprises cells that each have the same volume and the same dimensions in the three mutually perpendicular directions as well as having the same shape.

The randomised array of unit cells forms three-dimensional volume data may comprise iso-surfaces. The method may comprise rendering the iso-surfaces with polygons having faces and vertices to form a solid model of the stochastic structure. The solid model may be saved as an STL file or similar and imported to a printer or other additive manufacturing device or near-net shape manufacturing device and the stochastic structure manufactured.

The implicit function of an object or part of an object may be any one or combination of an ellipsoid, a sphere, a polygon, a minimal surface, or a triply periodic minimal surface. The minimal surface, or the triply periodic minimal surface may have a thickness. In the case of the minimal surface or the triply periodic minimal surface its shape may be defined by the equation having at least the parameters x, y and z, at least the parameters x, y and z may be randomised in accordance with the present invention.

The geometry may be any one of a volume, an area or a line.

The position xcₙ, ycₙ, zcₙ may be the position of the centre of the object and the extent rxₙ, ryₙ, and rzₙ may be the distance from the centre in the three mutually perpendicular dimensions of the boundary of the object.

The statistical distribution may be any one of the group comprising Gaussian, Poisson, Weibull, Logarithmic. Although described with reference to Gaussian distribution these and other statistical distribution may be used in the present invention.

The randomising step may comprise selecting values greater than zero of the standard deviation σ from at least two of the group of parameters xcₙ, ycₙ, zcₙ.

The randomising step may comprise selecting values greater than zero of the standard deviation σ from at least two of the group of parameters rxₙ, ryₙ, and rzₙ.

The randomising step may comprise gradually changing the standard deviation σ value in any one or more direction of the three dimensions.

The stochastic structure may be a randomised volume of a larger structure. The method may comprise the step defining the randomised volume with a sine function, the sine function having an amplitude, a periodicity, a length, a thickness and a position within the larger structure.

The method may comprise the steps identifying the iso-surface in the three-dimensional volume data by virtue of the density being 1 or 0, 1 being in the volume, 0 being outside the volume, creating positive and negative values from the statistical distribution around its mean value and applying the negative values to 1 and positive value to 0. Thereby creating a randomised roughness to a surface of the parent structure.

The three-dimensional volume data may be any one of the group comprising binary or distance field data or signed-distance field data.

The array of unit cells may have an arrangement from any one of the group of arrangements comprising cubic, body centred cubic, face centred cubic, a combination of the cubic and face centred cubic.

The relative density RD may have a limit RD_{Limit} dependent on the arrangement of the array of unit cells. Where the relative density RD≥RD_{Limit} the stochastic structure may be closed cell. Where the relative density RD<RD_{Limit} the stochastic structure may be open cell.

In another aspect of the present invention there is provided a component comprising the stochastic structure formed by the method of any of the preceding paragraphs.

The component may be any one of a heat exchanger, a structural core, an acoustic panel, a frequency damper, a heat-shield, a recuperator, a filter, a catalytic converter, an impact absorber, a battery.

In another aspect of the present invention, a gas turbine engine comprises a component according to the preceding two paragraphs.

### BRIEF DESCRIPTION OF THE DRAWINGS

The above-mentioned attributes and other features and advantages of the present method and apparatus and the manner of attaining them will become more apparent and the present method and apparatus itself will be better understood by reference to the following description of embodiments of the present method and apparatus taken in conjunction with the accompanying drawings. The descriptions of the figures below are incorporated as part of the description of the present invention, wherein:

FIG. 1 a) shows a regular arrangement or grid of points. FIG. 1 b) illustrates isotropic randomness superimposed on the regular array of FIG. 1 a). FIG. 1 c) demonstrates anisotropic randomness added to the regular array FIG. 1 a).

FIG. 2 shows a program flow of a stochastic lattice script. A unit cell (UC) is selected, and its dimensions are defined. Then the lattice control volume is defined and the desired relative density is set. Then five tools can be applied to the defined volume: isotropic randomness, anisotropic randomness, graded randomness, layered randomness, and stochastic roughness. After that the relative density is adjusted to reach the desired relative density. Finally, the lattice's vertices and faces are created and saved as an STL file.

FIG. 3 a) shows a basic cube unit cell of the size uₓ, u_{y} and u_{z}. By subtracting the unit cells in FIGS. 3 b)-e) from FIG. 3 a), a Cubic, BCC, FCC and FCC+ unit cell is created. FIG. 3 g) shows the case of two overlapping circles where two segments S1 and S2 appear.

FIG. 4 a) Random Layer of thickness t at a height h and overall lattice dimensions of lx and lz in the x-z-plane. FIG. 4 b) A smooth surface represented by an isosurface at a threshold value of zero. The isosurface separates the solid material (1) from the void (0). Values close to the surface are selected according to a randomness value. For randomness values>0, every third zero surface value is selected, and for randomness values<0, every third one surface value is selected. FIG. 4 c) The rough surface was created by adding the roughness values to the selected surface values. This alters the isosurface and hence creates roughness.

FIG. 5: Isotropic randomness applied to a Cubic, BCC, FCC+ and FCC UC. The FCC UC is presented as manufactured by PBF. The randomness σ ranges from 0.00 over 0.15 to 0.3 mm.

FIG. 6: Six parameters of an FCC lattice were randomised by six different randomisation parameters. In a) to c), the ellipsoid's radii are randomised, while in d) to f), the ellipsoid's centre positions are randomised. Anisotropic randomness as illustrated in g) is achieved by superimposing all six demonstrated randomisation possibilities. Moreover, powder bed fusion was used to manufacture the anisotropic random lattice. The British five pence coin is 18 mm in diameter.

FIG. 7: Graded randomness is demonstrated in three different directions with three different randomisation values in FCC lattices a)-c). Superimposing the three different graded lattices results in an anisotropic graded randomness lattice d). Lattices a)-d) were also manufactured via PBF.

FIG. 8: shows three FCC lattices created with a stochastic layer by a sine function. FIG. 8 a) is a layer within the FCC structure where the amplitude of the sine function is zero, resulting in a flat layer. FIG. 8 b) By increasing the amplitude of the sine function, a sine function occurs within the lattice. FIG. 8 c) By changing the periodicity, the sine function is compressed in comparison to FIG. 8 b). FIG. 8 a)-c) lattices were manufactured via PBF.

FIG. 9: a) shows a smooth FCC lattice and b) shows a lattice with superimposed roughness. A PBF example of each lattice is presented. A British five pence coin (18 mm diameter) is shown as scale. The roughness in the PBF example in b) is indicated by an arrow.

FIG. 10 shows part of a turbine engine in a sectional view and in which incorporates the presently described stochastic structure.

FIG. 11 is a schematic illustration of one of the blades of the gas turbine engine shown in FIG. 10.

FIG. 12 a) shows a conventional and regular array of pedestals 122 on a combustor tile 120 for example and FIG. 12 b) shows an array of pedestals 126 in accordance with the present invention and that may be applied to gas turbine components 124 such as a heat shield of an end wall in a turbine, a combustor wall or tile and a turbine aerofoil of a blade or vane.

### DETAILED DESCRIPTION OF INVENTION

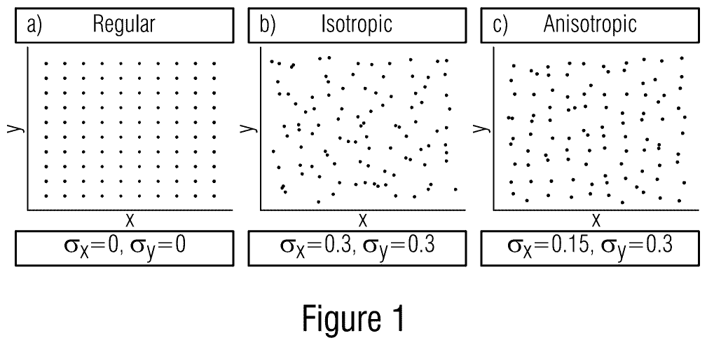

FIG. 1 a) shows a regular arrangement or grid of points. FIG. 1 b) illustrated isotropic randomness superimposed on the regular array shown in FIG. 1 a). FIG. 1 c) is demonstrating anisotropic randomness added to the regular array shown in FIG. 1 a). Consider a regular distribution of points in a 2D system where each point's x and y coordinates can be considered as a controllable parameter. To apply randomness to the regular array in FIG. 1 a), two simple cases exist isotropic and anisotropic randomness. The same randomness can be applied to the x and y parameter FIG. 1 b), which is isotropic randomness, or x and y have different randomness parameters in FIG. 1 c); this is anisotropic randomness. It can be seen that for a randomisation σₓ<σ_{y}, the dots appear to be more aligned in the y-direction than the x-direction as shown in FIG. 1 c) and when compared to FIG. 1 b).

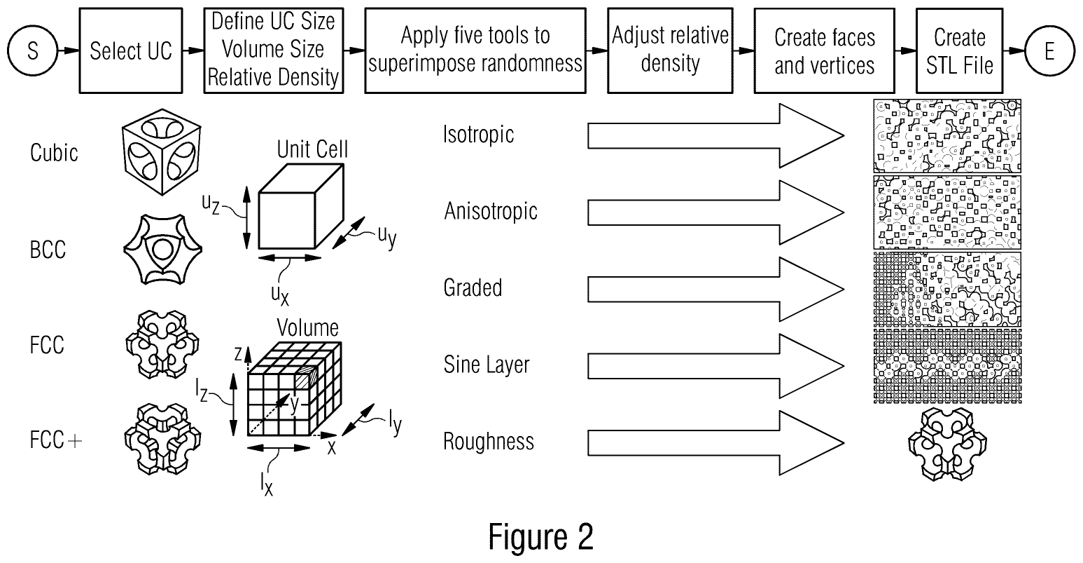

Describe here is a method to design a stochastic lattice. The general program flow can be seen in FIG. 2. Firstly, a desired ‘parent’ lattice UC is selected, for example, a cubic UC. Afterwards, the UC parameters are defined. These parameters are the cell size uₓ, u_{y} and u_{z}, the lattice volume dimensions lₓ, l_{y} and l_{z}, and the relative density RD. The relative density RD is the ratio of volume of the material forming the lattice to the overall volume of a given geometric shape of the lattice. Then the randomisation process is defined: isotropic randomness, anisotropic randomness, graded randomness, layered randomness or stochastic roughness. For each randomness process, specific parameters are defined to create the randomness. After the randomisation process, the relative density is adjusted to achieve a desired relative density. The relative density RD can be chosen to create an open cell lattice or a closed cell lattice or even a lattice with both open and closed cells. Subsequently, the faces and vertices of the lattice are determined and then saved in an STL file. Known software interpolates the three-dimensional volume data of randomised nodes or points and comprises iso-surfaces wherein the iso-surfaces are rendered by simple polygons. The simple polygons are created through well-known algorithms such as the marching cube or marching tetrahedra algorithm. This processing results in a set of faces and vertices defining the lattice. These faces and vertices can be saved as face normals and vertices in a commonly used format for 3D printing, such as an STL file format. An additive manufacturing or printing process then forms the stochastic lattice structure.

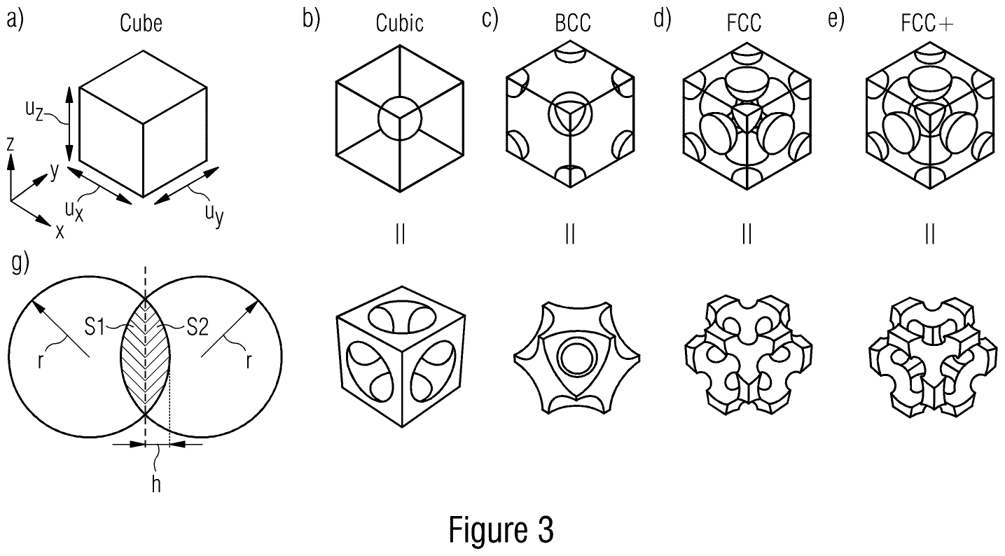

Referring now to FIG. 3 and a regular lattice shown in FIG. 3 a). Considering a unit cell (UC) in the shape of a cube. The length of each side can be described by uₓ, u_{y} and u_{z}. A UC is the initial regular structure that is periodically distributed within the desired design space. Here we populate the UC with any one of a cubic, a body-centred cubic (BCC), a face-centred cubic (FCC), and a FCC+ UC. The FCC+ UC is the union of the cubic and FCC UC. These UCs are shown in FIG. 3 b)-e). On each of the points or nodes defined within the UC a sphere is placed. The sphere can be calculated by the implicit function of an ellipsoid given in equation (1) below.

$$ϕ ( {xc}_{n} , {yc}_{n} , {zc}_{n} , {rx}_{n} , {ry}_{n} , {rz}_{n} ) = \frac{{xc}_{n}^{2}}{{rx}_{n}^{2}} + \frac{{yc}_{n}^{2}}{{ry}_{n}^{2}} + \frac{{zc}_{n}^{2}}{{rz}_{n}^{2}} \qquad ( 1 )$$

An ellipsoid is chosen to create a sphere enabling control over several parameters when applying the randomisation. In this way the sphere can be stretched into numerous directions. Here, xcₙ, ycₙ, zcₙ describe the n-th ellipsoid's centre position, while rxₙ, ryₙ, and rzₙ describe n-th ellipsoid's radius in the x, y, and z directions. The applied relative density RD defines the final volume V_{Lattice} of the lattice by equation (2).

$${V}_{Lattice} = RD \cdot {V}_{cube} \qquad ( 2 )$$

Where the cube's volume V_{cube} is defined by equation (3) if, as in this case, uₓ=u_{y}=u_{z}.

$${V}_{cube} = {u}_{x}^{3} \qquad ( 3 )$$

To determine the sphere's radius, the following equations are solved for two special cases, equation (4). Case 1: RD≥RD_{Limit} is a closed-cell structure, and Case 2: is an open-cell structure RD<RD_{Limit}. p is the number of spheres within one UC, and q is the number of overlapping segments. RD_{Limit} is the point where the UC transitions from closed cells to open cells.

$${V}_{Lattice} = \{ \begin{matrix}{V}_{Cube} - p \cdot {V}_{Sphere} & RD \geq {RD}_{Limit} \\ {V}_{Cube} - p \cdot {V}_{Sphere} + q \cdot {V}_{Segment} & RD < {RD}_{Limit}\end{matrix} \qquad ( 4 )$$

The UC parameters p, q, and RD_{Limit} are described in table. 1.

TABLE 1

| Unit Cell | p | q | RD_{Limit} |
|---|---|---|---|
| Cubic | 1 | 6 | $1 - \frac{1 \cdot π}{6}$ |
| BCC | 2 | 16 | $1 - \frac{\sqrt{2} \cdot π}{8}$ |
| FCC | 4 | 48 | $1 - \frac{\sqrt{2} \cdot π}{6}$ |
| FCC+ | 5 | 12 | $1 - \frac{5 \cdot π}{48}$ |

Table 1 comprises the parameters to determine the radius of a Cubic, BCC, FCC, and FCC+ UC. p is the number of full spheres within a UC, q is the total number of overlaps and RD_{Limit} is the limit where the UC shifts from a closed-cell to an open-cell.

The sphere in equation (4) is described by equation (5).

$${V}_{Sphere} = \frac{4 \cdot π}{3} \cdot {r}^{3} \qquad ( 5 )$$

Each segment's volume V_{Segment} is calculated by equation (6) due to overlapping spheres, where h is the height of one segment, as shown in FIG. 2 g).

$${V}_{Segment} = \frac{π}{3} \cdot {( r - h )}^{2} \cdot ( 2 \cdot r + h ) \qquad ( 6 )$$

Referring now to the step of parameter randomisation, to randomise the lattice structure, it is necessary to superimpose a random distribution to all of the parameters describing the ellipsoid equation (1). This gives a total of six parameters that can be subject to randomisation. For simplicity, only the randomisation process for xcₙ is described, but the randomisation process is the same for all other parameters. The randomisation is introduced by moving xcₙ by a certain random distance Δxcₙ, described by equation (7), which gives a randomised value xcranₙ.

$${xcran}_{n} = {xc}_{n} + Δ {xc}_{n} \qquad ( 7 )$$

The random distance xcₙ is created by a Gaussian distribution, equation (8).

$$f ( {xc}_{n} \vert μ , σ ) = \frac{1}{\sqrt{2 π} \cdot σ} \cdot {e}^{- 0.5 \cdot {( \frac{{xc}_{n} - μ}{σ} )}^{2}}$$

A mean value μ describes the Gaussian distribution. Here, μ is assigned to be zero because the parameters of the regular UC were already defined. The standard deviation σ is the control parameter (or randomisation value), used to control the space where the random values are created. For a Gaussian distribution, roughly 68%, 95%, and 99% of randomly distributed values are created within σ, 2σ, and 3σ, respectively. This allows describing isotropic and anisotropic randomness geometrically (see FIG. 1).

Referring now to forming a structure having graded randomness. Lattice parameters like the cell size, strut thickness or wall thickness may be graded. However, any parameter can be graded by the same principle. Here the standard deviation σ of the Gaussian random distribution equation (8) is graded by a linear function defined in equation (9) in the x-direction. It is the same for the y and z-directions. Consider position x=0 with a randomisation of σₓ₌₀, and x=lₓ with a randomisation of σx=lx. Then a linear gradient increases the randomness from position 0 to position lₓ from, for example, σ=0 to σ=0.3.

$$σ ( x ) = \frac{{σ}_{x = {l}_{x}} - {σ}_{x = 0}}{{l}_{x}} \cdot x + {σ}_{x = 0} \qquad ( 9 )$$

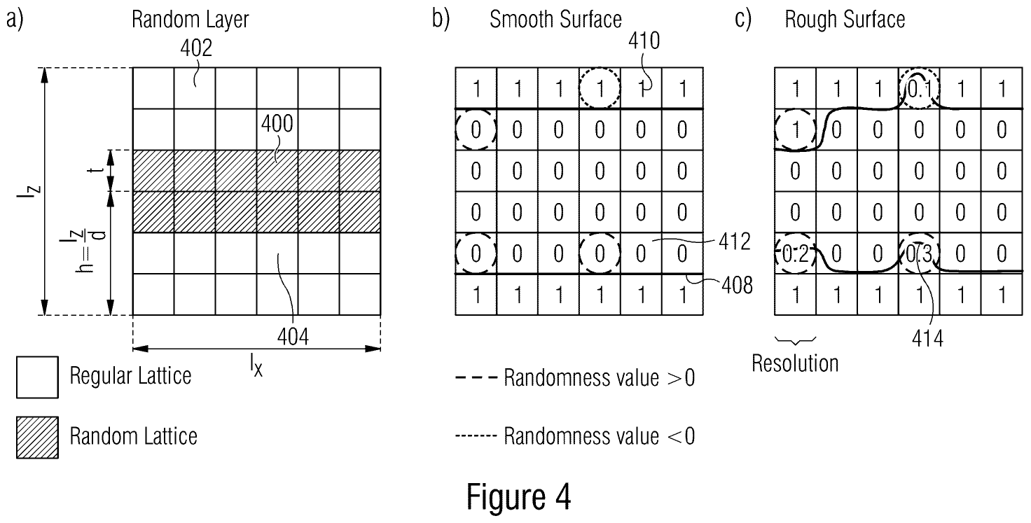

It is also possible to design and manufacture a lattice having a sandwich structure, where a randomised lattice layer 400 is enclosed within two regular lattice layers 402, 404, see FIG. 4 a). Alternatively, the two lattice layers 402, 404 may be graded or anisotropic. Here the layer is demonstrated by a 2D section in the x-z plane with a length of lₓ and l_{z}. A height h describes this layer 400 within the lattice volume. This height h describes the position within the volume and depends on the length of the volume in z-direction l_{z} and divider d. d determines at which position the layer 400 is formed. The layer 400 has a thickness, which can be described by t. To describe this flat layer, a sine function is used to increase its versatility. This layered lattice is useful to tailor control fluid flow through the lattice or attenuate vibration problems. Assuming that all ellipsoids have been created and form a volume with a regular lattice structure; each ellipsoid's radii rx_{i,j,k}, ry_{i,j,k}, rz_{i,j,k}, and centre positions xc_{i,j,k}, yc_{i,j,k}, zc_{i,j,k} can be described. i, j, k represent the matrix coordinates where each value is stored. To find the suitable i, j, k values for zc_{i,j,k} to achieve a sine layer, the value k is expressed by a sine function that propagates along the x-direction, which is i. Then k is described by equation (10). In equation (10), a is the amplitude, pd is the periodicity, and h is the already described height.

$$k ( i ) = round ( a \cdot sin ( pd \cdot i ) + h ) \qquad ( 10 )$$

The randomisation of the ellipsoid's centre coordinates and radii can be described by equation (11). Here z_{i,j,k} is used in this example but the procedure is the same for the other coordinates and radii. Δz_{i,j,k} is the randomisation value that originates from equation (8).

$${z}_{i , j , k} = {z}_{i , j , k} + Δ {z}_{i , j , k} \qquad ( 11 )$$

The thickness of the layer at k is just one layer of points. To create thickness, thickness is determined by setting the point layer within the matrix between −t to t. Then the layer can be described by equation (12).

$$- t < i < t \qquad ( 12 )$$

Referring to FIG. 4 a) shows a random layer 400 of thickness t at a height h and overall lattice dimensions of lx and l_{z} in the x-z-plane. FIG. 4 b) shows a smooth surface represented by an isosurface 408 at a threshold value of zero. The isosurface separates the solid material (1) from the void (0). Values close to the surface are selected according to a randomness value. For randomness values>0, every third zero surface value is selected, and for randomness values<0, every third one surface value is selected. FIG. 4 c) shows the rough surface was created by adding the roughness values to the selected surface values. This alters the isosurface 414 and hence creates roughness.

The surface of any lattice created by the method herein can be described by an isosurface at a threshold value of zero, represented by a line 408 in FIG. 4 b). This is the boundary between the solid (1) 410 and the void (0) 412 within the control volume. To create stochastic surface roughness, this surface is manipulated so that the isosurface becomes irregular and therefore rough. This is achieved by finding the transition from 0 to 1 or 1 to 0 in the control volume V_{i,j,k}. Then the Gaussian random distribution equation (8) is used to create positive and negative values of Δ_{rough} around the mean value μ_{rough}=0 by controlling σ_{rough}. The negative values are then added to 1 and the positive values to 0, see equation (13). If the roughness value is zero, no roughness is added.

$${V}_{i , j , k} = \{ \begin{matrix}1 + Roughness & if Roughness < 0 \\ 0 + Roughness & if Roughness > 0\end{matrix} \qquad ( 13 )$$

This results in a rough surface 414 seen in FIG. 4 c). Here we manipulate every third value or UC. This results in an isosurface 414 with irregularities/roughness. The roughness depends on the selected resolution. Hence, the roughness will vary between the two matrice's entries.

Table 2 below shows the lattice parameters that were used to design the lattices described herein and in particular below. The parameter U_{x,y,z} is the UC size. l_{x,y,z} the expansion of the lattice in the x, y and z-direction. RD is the relative density, MR is the mesh resolution and d, t, p are the divider, thickness and periodicity respectively that define the sine function.

TABLE 2

| Function | U_{x, y, z} | | lₓ/l_{y}/l_{z}(mm) | RD | MR | d | t | p |
|---|---|---|---|---|---|---|---|---|
| Isotropic | 5 | mm | 25/25/25 | 0.2 | 0.2 mm | — | — | — |
| Anisotropic | 5 | mm | 25/25/25 | 0.2 | 0.2 mm | — | — | — |
| Grading | 5 | mm | 50/25/25 | 0.2 | 0.2 mm | — | — | — |
| Sine 0 | 5 | mm | 25/25/25 | 0.2 | 0.2 mm | 2 | 4 | 1 |
| Sine I | 5 | mm | 25/25/25 | 0.2 | 0.2 mm | 2 | 4 | 0.25 |
| Sine II | 5 | mm | 25/25/25 | 0.2 | 0.2 mm | 2 | 4 | 0.5 |
| Roughness | 10 | mm | 60/30/30 | 0.2 | 0.2 mm | — | — | — |

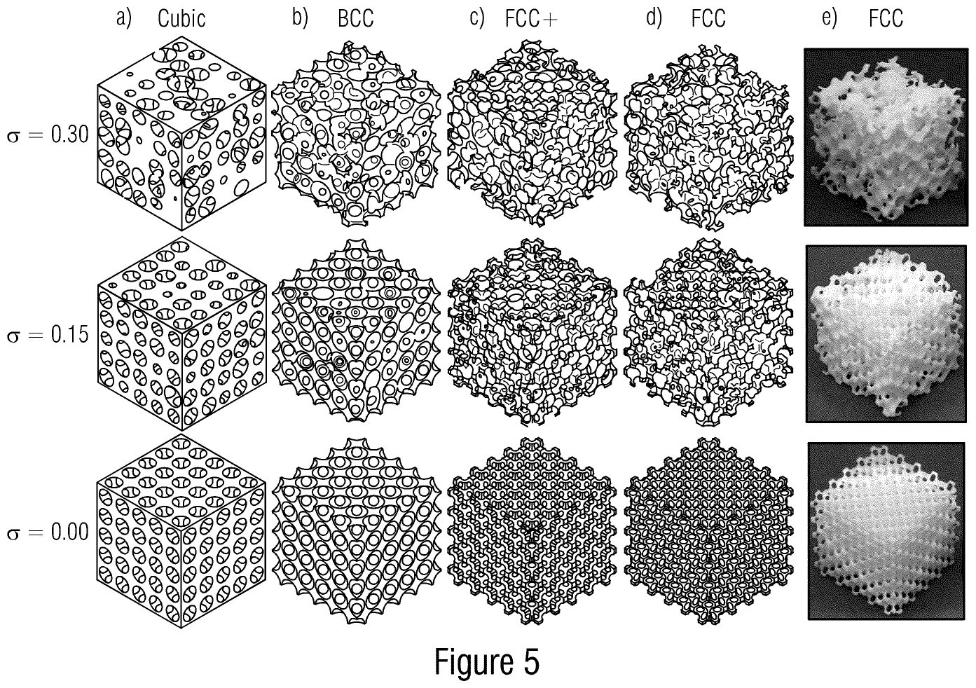

FIG. 5 demonstrates the isotropic randomness applied to lattices composed of Cubic, BCC, FCC+ and FCC UCs, demonstrating the versatility of the present method. A randomness of σ=0, σ=0.15, and σ=0.3 was applied to each lattice. At σ=0 all lattices are regular. By increasing the randomness to σ=0.15, and σ=0.3, it can be seen how the randomness increases. The FCC lattice structure was manufactured through a powder bed fusion process (PBF).

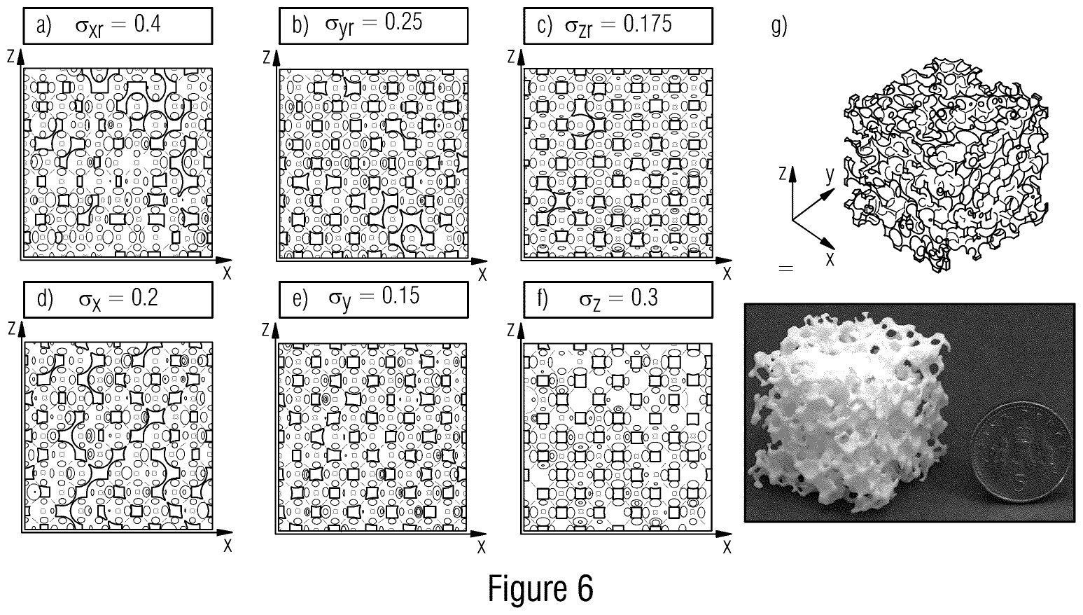

Anisotropic randomness is shown in FIG. 6, where every ellipsoid's parameter (equation (1)) has a different randomisation value σ. FIG. 6 a)-c) show the randomisation of the radii in the x, y, and z-direction. FIG. 6 d)-f) show the randomisation of the centre position of each ellipsoid. An anisotropic lattice structure is constructed by superimposing all six different randomisation possibilities as illustrated in FIG. 6 g). In the bottom part of FIG. 6 g), a PBF example of the anisotropic lattice is shown.

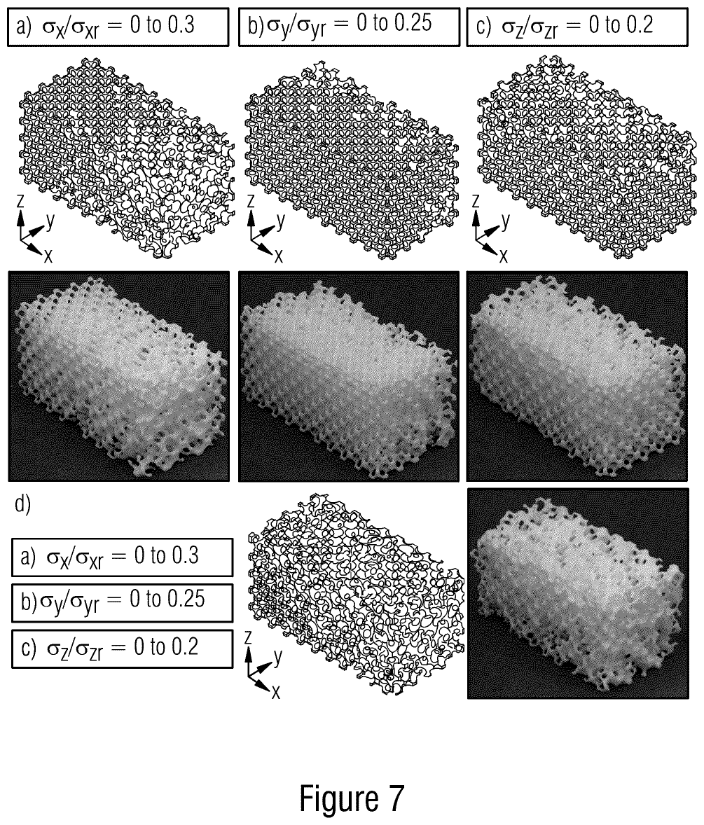

FIG. 7 shows four examples of grade randomness applied to an FCC lattice. FIG. 7 a)-c) show the principles of grading the ellipsoid's radius and centre randomisation in x, y, and z-direction, respectively. In a) the lattice is graded from 0 to 0.3, in b) from 0 to 0.25 and c from 0 to 0.2. All three examples show how the initial regular structure gradually becomes more random. An anisotropic graded randomness lattice can be created by superimposing these three examples as shown by way of example in FIG. 7 d). d) shows the regular structure in the lower-left corner, while the graded randomness is different in all directions. The four demonstrated graded randomness lattices were also manufactured by PBF to demonstrate manufacturability. The additive manufactured lattices are shown below a)-c) and on the right of d).

Optimal heat transfer versus pressure loss of fluids in components, for example a heat exchanger or a turbine blade, has been found to occur in a presently randomised structure where the randomisation is between 0.025 and 0.2 and more preferably between 0.05 and 0.15. A particularly good example of the degree of randomisation of the array of cells in a heat exchanger was found to be 0.05. A particularly good example of the degree of randomisation of the array of cells in a turbine blade was found to be 0.15.

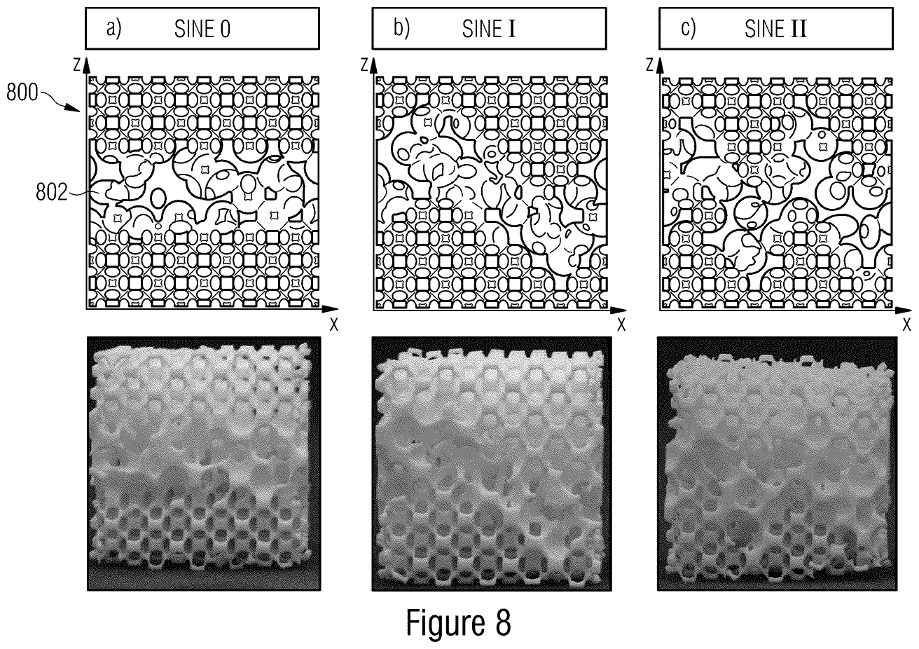

FIG. 8 shows a layer 802 with randomness in an FCC lattice cube 800. As demonstrated in FIG. 8 a), a flat layer can be constructed via equation (10) if the amplitude a is set to zero, this has the effect that the sine part of the equation (10) is not applied. However, increasing the amplitude a, and changing the periodicity p a sine layer is created as seen in FIG. 8 b). Through increasing the periodicity p, shown in FIG. 8 c), the sine layer can be compressed, or put another way the frequency is increased. It can also be seen that these three examples of the stochastic layer may be manufactured via PBF.

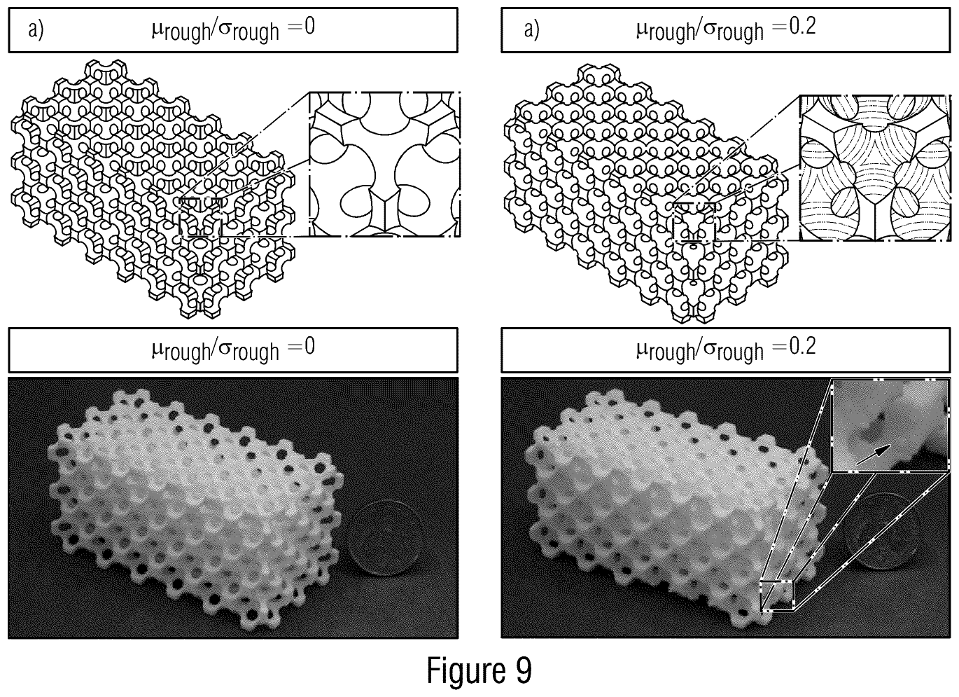

Surface roughness is illustrated in FIG. 9 which shows two FCC type lattices of the same size. FIG. 9 a) shows an original lattice that includes no roughness. Therefore, a smooth surface can be seen in the magnification. Superimposing a roughness (μ_{rough} and σ_{rough}=0.2) results in a rough surface lattice as demonstrated in magnification shown in FIG. 9 b). Through additive manufacturing the lattices shown in FIG. 9 a) and b), it can be seen that the surface roughness can also be replicated via additive manufacturing, note the protrusion in the magnification on the lower image of Figure. 9 b).

Herein is described a method of generating a number of stochastic lattices. First, a regular location array has positioned on it spheres to create commonly known lattice types. Then superimposed are various types of randomness on the sphere's location and manipulated the sphere's radii by assuming the sphere is an ellipsoid. This results in a number of ways to design stochastic lattices. Isotropic randomness is when the same randomness value is used for each manipulatable parameter. Anisotropic randomness is when the randomness value is different for each parameter. Graded randomness is when the randomness value changes from a minimum value to a maximum value according to its location. A stochastic layer is a layer that is enclosed between two regular structures, has a specific thickness, location and can be flat or arcuate. A stochastic surface roughness is used to roughen the surface by a certain randomness value over the whole structure. The results are methods that can be applied in many engineering applications.

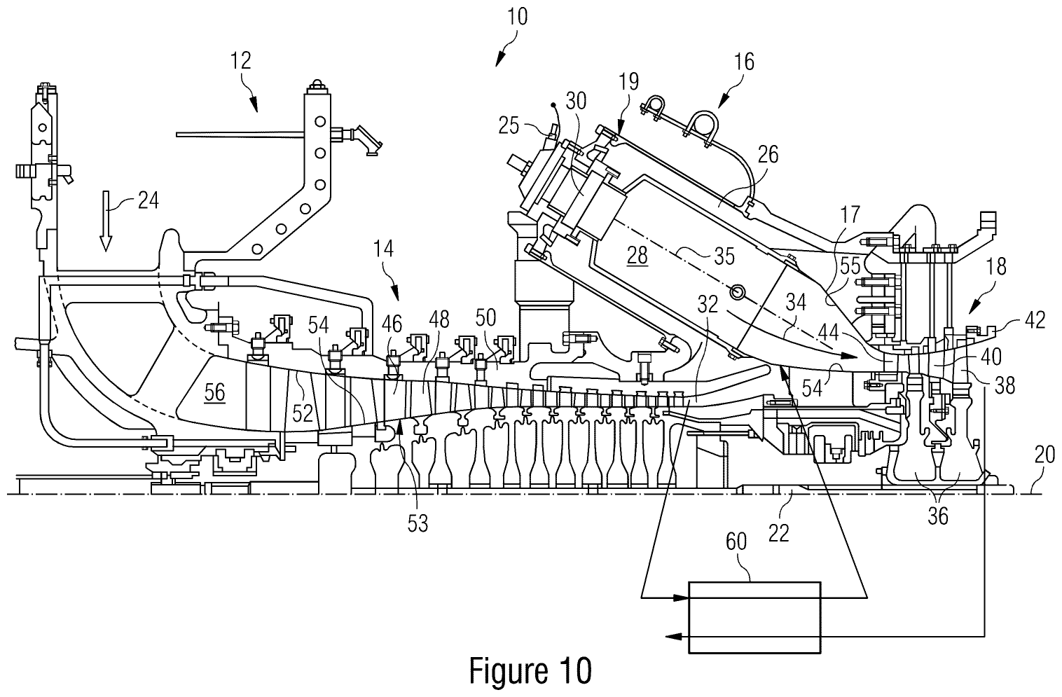

FIG. 10 shows an example of a gas turbine engine 10 in a sectional view. The gas turbine engine 10 comprises, in flow series, an inlet 12, a compressor section 14, a combustor section 16 and a turbine section 18 which are generally arranged in flow series and generally about and in the direction of a longitudinal or rotational axis 20. The gas turbine engine 10 further comprises a shaft 22 which is rotatable about the rotational axis 20 and which extends longitudinally through the gas turbine engine 10. The shaft 22 drivingly connects the turbine section 18 to the compressor section 14.

In operation of the gas turbine engine 10, air 24, which is taken in through the air inlet 12 is compressed by the compressor section 14 and delivered to the combustion section or burner section 16. The burner section 16 comprises a burner plenum 26, one or more combustion chambers 28 and at least one burner 30 fixed to each combustion chamber 28. The combustion chambers 28 and the burners 30 are located inside the burner plenum 26. The compressed air passing through the compressor 14 enters a diffuser 32 and is discharged from the diffuser 32 into the burner plenum 26 from where a portion of the air enters the burner 30 and is mixed with a gaseous or liquid fuel. The air/fuel mixture is then burned and the combustion gas 34 or working gas from the combustion is channelled through the combustion chamber 28 to the turbine section 18 via a transition duct 17.

This exemplary gas turbine engine 10 has a cannular combustor section arrangement 16, which is constituted by an annular array of combustor cans 19 each having the burner 30 and the combustion chamber 28, the transition duct 17 has a generally circular inlet that interfaces with the combustor chamber 28 and an outlet in the form of an annular segment. An annular array of transition duct outlets form an annulus for channelling the combustion gases to the turbine 18.

The turbine section 18 comprises a number of blade carrying discs 36 attached to the shaft 22. In the present example, two discs 36 each carry an annular array of turbine blades 38. However, the number of blade carrying discs could be different, i.e. only one disc or more than two discs. In addition, guiding vanes 40, which are fixed to a stator 42 of the gas turbine engine 10, are disposed between the stages of annular arrays of turbine blades 38. Between the exit of the combustion chamber 28 and the leading turbine blades 38 inlet guiding vanes 44 are provided and turn the flow of working gas onto the turbine blades 38. The turbine section 18 comprises a turbine casing 51 that surrounds the turbine blades 38 and defines a radially outer surface 55 of a working gas path 57. A radially inner surface 59 further defines the working gas path 57. Parts of the radially inner surface 59 and the radially outer surface 55 are defined by platforms of the blades and stator vanes as is well known. A tip gap is defined between the tip of the blades 38 and the casing 51 or radially outer surface 55.

The combustion gas from the combustion chamber 28 enters the turbine section 18 and drives the turbine blades 38 which in turn rotate the shaft 22. The guiding vanes 40, 44 serve to optimise the angle of the combustion or working gas on the turbine blades 38.

The turbine section 18 drives the compressor section 14. The compressor section 14 comprises an axial series of vane stages 46 and rotor blade stages 48. The rotor blade stages 48 comprise a rotor disc supporting an annular array of blades. The compressor section 14 also comprises a compressor casing 50 that surrounds the rotor stages and supports the vane stages 46. The guide vane stages include an annular array of radially extending vanes that are mounted to the compressor casing 50. The vanes are provided to present gas flow at an optimal angle for the blades at a given engine operational point. Some of the guide vane stages have variable vanes, where the angle of the vanes, about their own longitudinal axis, can be adjusted for angle according to air flow characteristics that can occur at different engine operations conditions.

The compressor casing 50 defines a radially outer surface 52 of the passage 56 of the compressor 14. A radially inner surface 54 of the passage 56 is at least partly defined by a rotor drum 53 of the rotor and which is partly defined by the annular array of blades 48.

The present invention is described with reference to the above exemplary turbine engine having a single shaft or spool connecting a single, multi-stage compressor and a single, one or more stage turbine. However, it should be appreciated that the present invention is equally applicable to two or three shaft engines, and which can be used for industrial, aero or marine applications.

The terms upstream and downstream refer to the flow direction of the airflow and/or working gas flow through the engine unless otherwise stated. The terms forward and rearward refer to the general flow of gas through the engine. The terms axial, radial and circumferential are made with reference to the rotational axis 20 of the engine.

The gas turbine 10 comprises a heat exchanger 60. The heat exchanger 60 is just one example of a heat exchanger, recuperator or intercooler device that can be positioned and function in an otherwise known manner. Here compressed air from a downstream part of the compressor 14 is channelled through the heat exchanger 60 and gains heat from gases channelled through the heat exchanger 60 from a downstream part of the turbine 18. The hotter compressor air provides a benefit to combustion. Incorporating the stochastic structure in accordance with the present invention can increase heat transfer by virtue of the gases passing through the stochastic structure more effectively and efficiently. In a regular lattice structure fluids often incur stagnant regions of flow due to the repetitive lattice structure. In the stochastic structure the randomisation of the structure prevents fluids from stagnating because the changing or randomised structure disrupts steady flow conditions. It is understood that the stochastic structure increased heat transfer and reduces the pressure loss for the same volume or hydraulic diameter of a known heat exchanger.

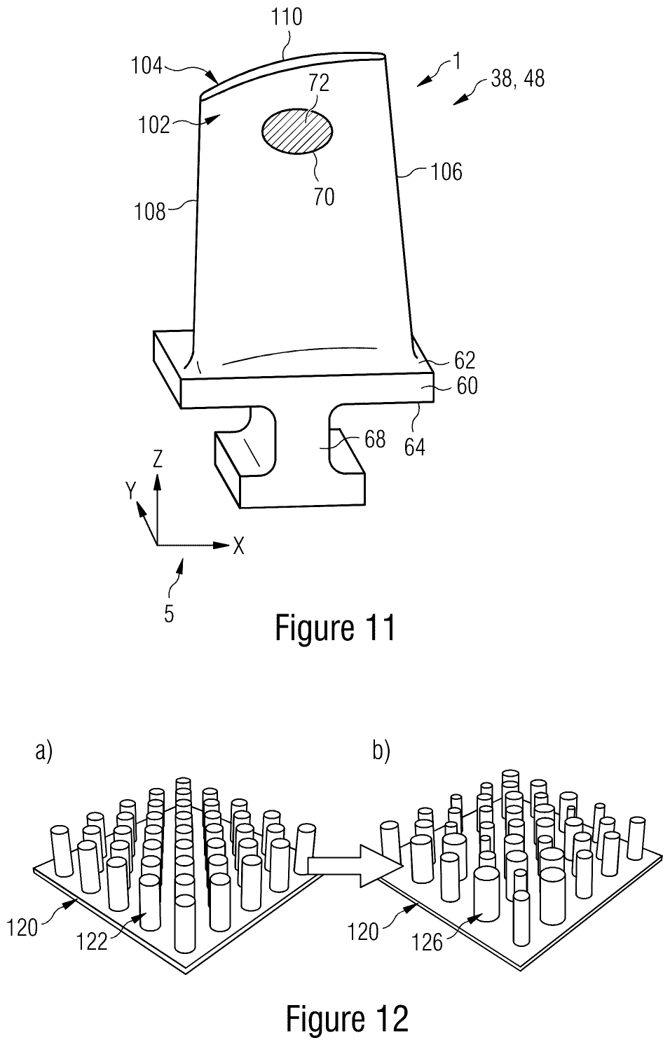

Referring now to FIG. 11 which is a schematic illustration of one of the blades 38, 48 of the gas turbine engine 10 shown in FIG. 10. The blade 38, 48 comprises a root 68 for securing to a rotor disc, a platform 60 and mounted thereon an aerofoil 1. The aerofoil 1 comprises a pressure wall 102 and a suction wall 104 which meet at a leading edge 108 and a trailing edge 106. The aerofoil has a tip 110. A cut-away 70 in the pressure wall 102 reveals an interior volume which comprises the stochastic structure as hereinbefore described. Cooling channels are formed through the stochastic structure to improve heat transfer to a coolant passing through the cooling channels from the pressure and suction walls 102, 103 of the blade, particularly a turbine blade 48. The stochastic structure may provide enhanced structural integrity of the blade while minimising weight. Furthermore, the stochastic structure may be gradually randomised, have a specific volume randomised or have a varying relative density to modulate the blade's response to vibrations and provide attenuation.

FIG. 12 a) shows a conventional and regular array of pedestals 122 on a combustor tile 120 for example and FIG. 12 b) shows an array of pedestals 126 in accordance with the present invention and that may be applied to gas turbine components 124 such as a heat shield of an end wall in a turbine, a combustor wall or tile and a turbine aerofoil of a blade or vane. In FIG. 12 a) each row of pedestals is off-set from the adjacent one and all the pedestals are spaced regularly from one another. The size and shape of these known pedestals is constant throughout the array. Referring to FIG. 12 b), the array of pedestals 126 have pedestals of randomised size, position and spacing. The present method of forming a stochastic structure comprises the parent structure being a regular array of pedestals, e.g. 122, and the array of unit cells being the individual pedestals.

All the features disclosed in this specification (including any accompanying claims, abstract and drawings), and/or all the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of forming a stochastic structure, the method comprising:
selecting a parent structure, the parent structure defining an array of unit cells, initially the array of unit cells is uniform,
defining each unit cell of the array of unit cells a size, a geometry, a relative density and at least one node,
placing an implicit function of an object or part of an object at each node, wherein the object having parameters to define its position xcₙ, ycₙ, zcₙ, and extent rxₙ, ryₙ, and rzₙ or a shape defined by an equation having at least the parameters x, y and z,
randomising any one or more of the parameters by applying a statistical distribution, the statistical distribution having a standard deviation σ, the standard deviation σ controls at least one of the three dimensions where random values of each parameter are created,
selecting a value greater than zero of the standard deviation σ to define the degree of randomisation for any one or more of the parameters, thereby creating a randomised array of unit cells representative of the stochastic structure, wherein the randomised array of unit cells forms three-dimensional volume data comprising iso-surfaces, and
rendering the iso-surfaces with polygons having faces and vertices to form a solid model of the stochastic structure.

2. The method of forming a stochastic structure as claimed in claim 1, wherein the implicit function of an object or part of an object is any one or combination of an ellipsoid, a sphere, a polygon, a minimal surface, or a triply periodic minimal surface, wherein the minimal surface, or the triply periodic minimal surface has a thickness.

3. The method of forming a stochastic structure as claimed in claim 1, wherein the geometry is any one of a volume, an area or a line.

4. The method of forming a stochastic structure as claimed in claim 1, wherein the position xcₙ, ycₙ, zcₙ is the position of the centre of the object and the extent rxₙ, ryₙ, and rzₙ is the distance from the centre in the three mutually perpendicular dimensions of the boundary of the object.

5. The method of forming a stochastic structure as claimed in claim 1, wherein the statistical distribution is selected from the group consisting of a Gaussian statistical distribution, a Poisson statistical distribution, a Weibull statistical distribution, and a Logarithmic statistical distribution.

6. The method of forming a stochastic structure as claimed in claim 1, wherein the randomising step comprises selecting values greater than zero of the standard deviation σ from at least two of the group of parameters xcₙ, ycₙ, zcₙ.

7. The method of forming a stochastic structure as claimed in claim 1, wherein the randomising step comprises selecting values greater than zero of the standard deviation σ from at least two of the group of parameters rxₙ, ryₙ, and rzₙ.

8. The method of forming a stochastic structure as claimed in claim 1, wherein the randomising step comprises gradually changing the standard deviation σ value in any one or more direction of the three dimensions.

9. The method of forming a stochastic structure as claimed in claim 1, wherein the stochastic structure is a randomised volume of a larger structure, wherein the method further comprises defining the randomised volume with a sine function, the sine function having an amplitude, a periodicity, a length, a thickness and a position within the larger structure.

10. The method of forming a stochastic structure as claimed in claim 1, wherein the method further comprises
identifying the iso-surface in the three-dimensional volume data by virtue of the density being 1 or 0, 1 being in the volume, 0 being outside the volume,
creating positive and negative values from the statistical distribution around its mean value and
applying the negative values to 1 and positive value to 0, thereby creating a randomised roughness to a surface of the parent structure.

11. The method of forming a stochastic structure as claimed in any claim 1, wherein the three-dimensional volume data is any one of the group comprising binary or distance field data or signed-distance field data.

12. The method of forming a stochastic structure as claimed in claim 1, wherein the array of unit cells has an arrangement from any one of the group of arrangements comprising cubic, body centred cubic, face centred cubic, a combination of the cubic and face centred cubic.

13. The method of forming a stochastic structure as claimed in claim 12,
wherein the relative density RD has a limit RD_{Limit} dependent on the arrangement of the array of unit cells, and
wherein where the relative density RD≥RD_{Limit} the stochastic structure is closed cell and where the relative density RD<RD_{Limit} the stochastic structure is open cell.

14. A component comprising the stochastic structure formed by the method of claim 1.

15. The component as claimed in claim 14 wherein the component is any one of a heat exchanger, a structural core, an acoustic panel, a frequency damper, a heat-shield, a recuperator, a filter, a catalytic converter, an impact absorber, a battery.

16. A gas turbine engine comprising a component according to claim 14.

17. The method of forming a stochastic structure as claimed in claim 1, further comprising printing the stochastic structure in an additive manufacturing process.
